(19) United States
(12) Patent Application Publication
(10) Pub. No.: US 2007/0012209 A1
(43) Pub. Date: Jan. 18, 2007

(54) Printing/coating machine

(75) Inventor: Shoichi Ichimura, Ibaraki (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Komori Corporation

(21) Appl. No.: 11/483,051

(22) Filed: Jul. 7, 2006

(30) Foreign Application Priority Data
Jul. 14, 2005 (JP) 205333/2005

(51) Int. Cl. B41F 35/00

(52) U.S. Cl. 101/424.1

(57) ABSTRACT

A printing/coating machine includes a blanket cylinder, impression cylinder, ultraviolet dryer, detector, and actuating plate. The blanket cylinder is supported rotatably. One of ink and varnish is supplied to an outer surface of the blanket cylinder. The impression cylinder is supported rotatably in contact with the blanket cylinder and prints/coats a transfer target body under conveyance with respect to the blanket cylinder. The dryer opposes a portion of the impression cylinder downstream of a contact position, where the blanket cylinder and the impression cylinder are in contact with each other, in a rotational direction of the impression cylinder, and dries a printed/coated surface of the transfer target body under conveyance by irradiation with light. The detector is arranged in the vicinity of the contact position where the blanket cylinder and the impression cylinder are in contact with each other and detects an abnormal state. The actuating plate is provided in relation to the detector and inhibits light, radiated from the dryer and reflected by the impression cylinder, from striking the outer surface of the blanket cylinder.

### BACKGROUND OF THE INVENTION

The present invention relates to a printing press/coating machine comprising a dryer which dries the printed/coated surface of a printed sheet with ultraviolet rays.

Generally, in a printing press/coating machine of this type, before a printed surface immediately after printing or a coated surface immediately after coating has not been dried, if next printing/coating is performed, the quality of the printed surface/coated surface degrades when the sheet is being wounded around an impression cylinder/transfer cylinder. Hence, a dryer which dries the printed/coated surface is provided.

In a conventional printing press, an obverse/reverse surface perfecting dryer is arranged above an obverse-surface printing impression cylinder, and a reverse-surface dryer is arranged below a reverse-surface printing impression cylinder. As the dryer, an infrared dryer which dries the printed surface by heating or an ultraviolet dryer which dries the printed surface by curing the ink instantaneously by ultraviolet irradiation is used, as shown in Japanese Patent Laid-Open No. 2000-52528.

In the conventional printing press described above, ultraviolet rays from the ultraviolet dryer to irradiate the surface of the impression cylinder strike and are reflected by the surface of the sheet or impression cylinder. The reflected light dries the ink supplied to a blanket cylinder which is in contact with the impression cylinder, to cause a printing trouble.

### SUMMARY OF THE INVENTION

It is an object of the present invention to provide a printing press and coating machine in which irradiation of the blanket cylinder with ultraviolet rays used for drying is regulated to prevent a printing trouble.

In order to achieve the above object, according to the present invention, there is provided a printing/coating machine comprising a first cylinder which is supported rotatably and has an outer surface to which one of ink and varnish is supplied, a second cylinder which is supported rotatably in contact with the first cylinder and which prints/coats a transfer target body under conveyance with respect to the first cylinder, a dryer which opposes a portion of the second cylinder downstream of a contact position, where the first cylinder and the second cylinder are in contact with each other, in a rotational direction of the second cylinder, and dries a printed/coated surface of the transfer target body under conveyance by irradiation with light, a detector which is arranged in the vicinity of the contact position where the first cylinder and the second cylinder are in contact with each other and detects an abnormal state, and a light-shielding member which is provided in relation to the detector and inhibits light, radiated from the dryer and reflected by the second cylinder, from striking the outer surface of the first cylinder.

### BRIEF DESCRIPTION OF THE DRAWINGS

FIG. 1 is a side view showing the periphery of the dryer of a printing press according to an embodiment of the present invention;

FIG. 2 is a plan view showing the main part of the periphery of the dryer of the printing press shown in FIG. 1;

FIG. 3 is an enlarged view of the main part of the periphery of the dryer shown in FIG. 1; and

FIG. 4 is an enlarged view of the main part of the periphery of the dryer shown in FIG. 2.

### DESCRIPTION OF THE PREFERRED EMBODIMENT

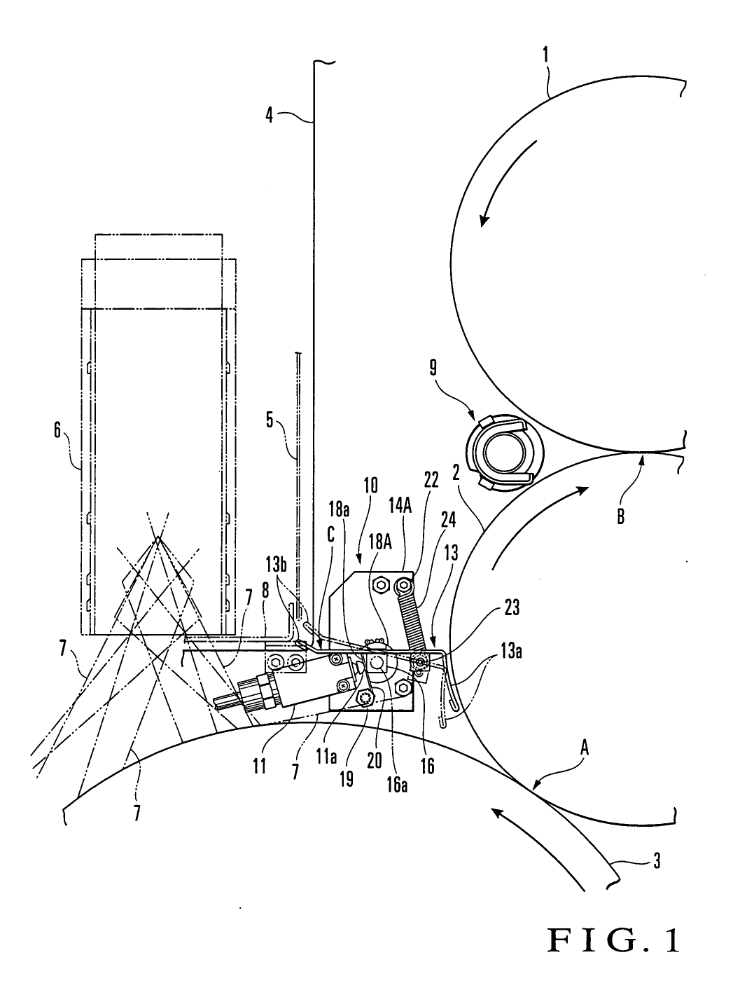

A printing press according to an embodiment of the present invention will be described with reference to FIGS. 1 to 4. Referring to FIG. 1, ink from an inking device (not shown) and water from a dampenining unit (not shown) are supplied to the outer surface of a plate cylinder 1 on which a plate cylinder is mounted. A blanket cylinder 2 (first cylinder) with a blanket wound around its outer surface is arranged such that the outer surfaces of the blanket cylinder 2 and plate cylinder 1 are in contact with each other. Ink corresponding to the pattern is transferred from the plate cylinder 1 to the blanket cylinder 2. An impression cylinder 3 (second cylinder) comprising grippers (not shown) which conveys a sheet as a transfer target body is arranged in contact with the blanket cylinder 2. The sheet under conveyance is printed while it passes between the impression cylinder 3 and blanket cylinder 2. The plate cylinder 1, blanket cylinder 2, and impression cylinder 3 are rotatably supported through bearings between a pair of frames 4 which are arranged to oppose each other at a predetermined distance, as is well-known as a printing press.

An openable/closeable safety cover 5 is arranged in front of the plate cylinder 1 and blanket cylinder 2. The safety cover 5, which is normally closed as indicated by an alternate long and two short dashed line in FIG. 1, opens when performing maintenance of the respective cylinders. An ultraviolet dryer (interdeck) 6 which radiates ultraviolet rays 7 to cure and dry the ink instantaneously is attached on a step 8 arranged between printing units. The ultraviolet dryer 6 is arranged to oppose the outer surface of the impression cylinder 3 at a position downstream of a contact position A, where the blanket cylinder 2 and impression cylinder 3 are in contact with each other, in the rotational direction of the impression cylinder 3. The ultraviolet dryer 6 dries the printed surface of the sheet being conveyed by the impression cylinder 3 by irradiating it with ultraviolet rays.

A known safety bar 9 is arranged in the vicinity of a contact position B where the plate cylinder 1 and blanket cylinder 2 are in contact with each other. The safety bar 9 extends in the axial direction of the plate cylinder 1 and is pivotally supported between the pair of frames 4 to be pivotal about the axis. The safety cover 5 and step 8 form a cover device. In this embodiment, both the safety cover 5 and step 8 are provided. If only one of the safety cover 5 and step 8 is provided, the provided safety cover 5 or step 8 may form the cover device.

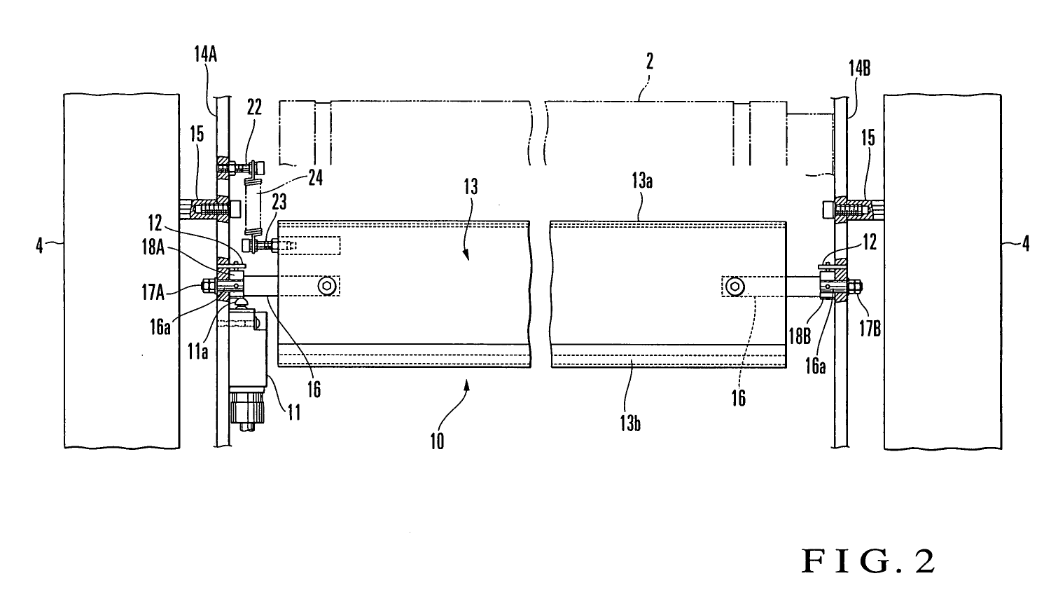

A detector 10 is arranged in the vicinity of the contact position A where the blanket cylinder 2 and impression cylinder 3 are in contact with each other. The detector 10 comprises a detection switch 11 having a switch portion 11a, and a thin, elongated band-like actuating plate 13 (actuating portion). When a work tool or the like comes into contact with the actuating plate 13, the actuating plate 13 is pivoted and presses the switch portion 11a to turn on the detection switch 11. When the detection switch 11 is turned on, rotation of the plate cylinder 1, blanket cylinder 2, and impression cylinder 3 is stopped. As shown in FIG. 2, a pair of inner frames 14A and 14B are fixed to the pair of frames 4 through studs 15 to be parallel to the frames 4. A pair of stoppers 12 respectively extend perpendicularly from the inner sides of the pair of inner frames 14A and 14B to oppose each other. The detection switch 11 is attached to one inner frame 14A.

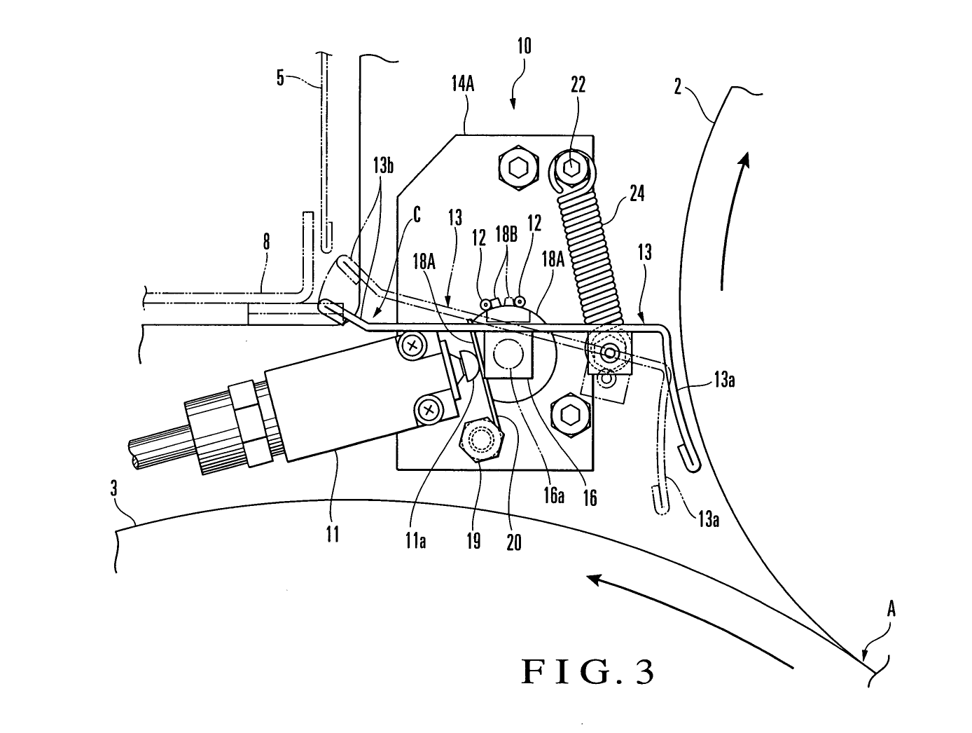

The actuating plate 13 which is L-shaped when seen from the side is arranged to extend between the pair of inner frames 14A and 14B. That front end of the actuating plate 13 which is close to the blanket cylinder 2 is bent substantially at a right angle along the longitudinal direction, as shown in FIG. 3. The front-end bent portion of the actuating plate 13 is curved concentrically along the outer surface of the blanket cylinder 2 to form a first light-shielding portion 13a. The horizontal proximal end portion of the actuating plate 13 forms a second light-shielding portion 13b which continues to the first light-shielding portion 13a in the widthwise direction of the actuating plate 13. The rear end of the second light-shielding portion 13b of the actuating plate 13 is bent at an obtuse angle when seen from the side, as shown in FIG. 3, and extends to a position close to the lower end of the safety cover 5. The respective edges of the first and second light-shielding portions 13a and 13b are folded back. In this manner, the first and second light-shielding portions 13a and 13b form a light-shielding member formed of the actuating plate 13.

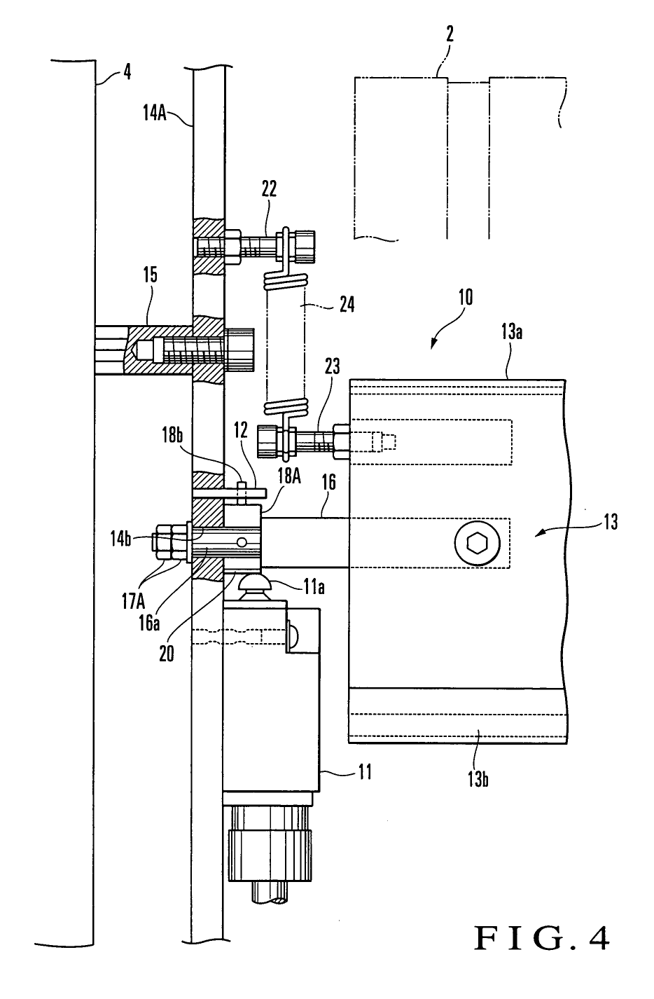

As shown in FIG. 4, a pair of stays 16 each having a square section are attached to the centers of the lower surfaces of the two ends of the actuating plate 13 in the axial direction of the blanket cylinder 2, such that the stays 16 partly project from the two ends of the actuating plate 13. Shaft portions 16a coaxial with the stays 16 and each having a square section are integrally provided to project from the projecting ends of the stays 16, respectively. The shaft portions 16a are respectively pivotally supported in bearing holes 14b formed in the pair of inner frames 14A and 14B. Axial movement of the shaft portions 16a is regulated by nuts 17A and 17B threadably engaging with the distal end threaded portions of the shaft portions 16a and ring-like collars 18A and 18B pivotally and axially mounted on the inner sides of the inner frames 14A and 14B. Hence, the actuating plate 13 is also supported by the pair of inner frames 14A and 14B through the stays 16 to be pivotal clockwise/counterclockwise in FIG. 3 about the shaft portions 16a as the center.

As shown in FIG. 3, a D-cut surface 18a opposing the switch portion 11a of the detection switch 11 is formed on part of the outer surface of one collar 18A. The free end of a leaf spring 20, a proximal end of which is attached to the inner frame 14A with a screw 19, is interposed between the D-cut surface 18a and switch portion 11a. A pin 18b which engages with stoppers 12 to set the pivotal range of the collar 18A extends vertically upward from the outer surface of the collar 18A. A tensile coil spring 24 is hooked between a spring catching member 22 attached to the inner frame 14A and a spring catching member 23 attached to the actuating plate 13. The actuating plate 13 is biased by the tensile force of the tensile coil spring 24 counterclockwise about the shaft portions 16a in FIG. 3 as a rotation center.

With the actuating plate 13 being biased, the first light-shielding portion 13a of the actuating plate 13 is located along the outer surface of the blanket cylinder 2 such that the edge of the first light-shielding portion 13a is directed toward the contact position A where the blanket cylinder 2 and impression cylinder 3 are in contact. Simultaneously, the edge of the second light-shielding portion 13b is located in the vicinity of the step 8 which is an extension of the lower end of the safety cover 5. The second light-shielding portion 13b shields a gap C which is between the outer surface of the blanket cylinder 2 and the safety cover 5 and step 8. At this time, the D-cut surface 18a of the collar 18A opposes the switch portion 11a of the detection switch 11 to set the switch portion 11a in an inoperative state.

In this state, when the work tool or the like comes into contact with the actuating plate 13, the actuating plate 13 pivots clockwise about the shaft portions 16a as a center, as indicated by an alternate long and two dashed line in FIG. 3, against the tensile force of the tensile coil spring 24. Hence, the switch portion 11a of the detection switch 11 is pressed by the outer surface of the collar 18A through the leaf spring 20 and turns on the detection switch 11.

Printed surface drying operation in the printing press having the above arrangement will be described. Referring to FIG. 1, when the sheet which is conveyed as it is gripped by the grippers of the impression cylinder 3 passes between the impression cylinder 3 and blanket cylinder 2, the obverse surface of the sheet is printed. When the sheet which is printed on its obverse surface and conveyed by the impression cylinder 3 reaches a position opposing the ultraviolet dryer 6, the ink is cured by the ultraviolet rays 7 radiated from the ultraviolet dryer 6, so the printed surface is dried.

At this time, some of the ultraviolet rays 7 that irradiate the printed surface strike the printed surface and the surface of the impression cylinder 3 and are reflected toward the blanket cylinder 2. As the first light-shielding portion 13a of the actuating plate 13 is arranged along the outer surface of the blanket cylinder 2, the reflected light is shielded by the first light-shielding portion 13a and does not irradiate the surface of the blanket cylinder 2. Thus, the ink on the outer surface of the blanket cylinder 2 is not dried by the reflected light of the ultraviolet rays 7, so a printing trouble can be prevented.

The gap C between the outer surface of the blanket cylinder 2 and the safety cover 5 and step 8 is shielded by the second light-shielding portion 13b of the actuating plate 13. Thus, some of the ultraviolet rays 7 irradiating the printed surface and reflected can be prevented from leaking outside the printing press through the gap C.

The first and second light-shielding portions 13a and 13b are provided to the actuating plate 13 of the detector 10. No dedicated light-shielding member need be provided additionally, so the structure is simple. As the number of components does not increase, the manufacturing cost does not increase.

The first light-shielding portion 13a is arranged along the outer surface of the blanket cylinder 2 so as not face the sheet convey path. Accordingly, the trailing edge of the sheet under conveyance does not come into contact with the first light-shielding portion 13a, so the sheet will not be damaged.

Although this embodiment is described exemplifying a printing press, this embodiment can also be applied to a coating machine which coats a transfer target body which passes between the first and second cylinders with varnish or the like supplied to the first cylinder. Although the two ends of the actuating plate 13 are folded to form the first and second light-shielding portions 13a and 13b, the second light-shielding portion 13b can be omitted.

As has been described above, according to the present invention, the first light-shielding portion inhibits the reflected light of the ultraviolet rays from striking the outer surface of the first cylinder. Thus, drying of the ink on the outer surface of the first cylinder and a printing trouble can be prevented. Since the light-shielding portion is provided to an existing detector, no dedicated light-shielding member need be provided additionally, so the structure can be simple. As the number of components does not increase, an increase in manufacturing cost can be inhibited.

What is claimed is:

1. A printing/coating machine comprising:
a first cylinder which is supported rotatably and has an outer surface to which one of ink and varnish is supplied;
a second cylinder which is supported rotatably in contact with said first cylinder and which prints/coats a transfer target body under conveyance with respect to said first cylinder;
a dryer which opposes a portion of said second cylinder downstream of a contact position, where said first cylinder and said second cylinder are in contact with each other, in a rotational direction of said second cylinder, and dries a printed/coated surface of the transfer target body under conveyance by irradiation with light;
a detector which is arranged in the vicinity of the contact position where said first cylinder and said second cylinder are in contact with each other and detects an abnormal state; and
a light-shielding member which is provided in relation to said detector and inhibits light, radiated from said dryer and reflected by said second cylinder, from striking said outer surface of said first cylinder.

2. A machine according to claim 1, wherein said light-shielding member further inhibits light, radiated from said dryer and reflected by said second cylinder, from leaking outside the machine.

3. A machine according to claim 2, wherein said light-shielding member comprises
a first light-shielding portion which inhibits the reflected light from said second cylinder from striking said outer surface of said first cylinder, and
a second light-shielding portion which inhibits the reflected light from said second cylinder from leaking outside the machine and inhibits the reflected light from striking said outer surface of said first cylinder.

4. A machine according to claim 3, wherein
said light-shielding member comprises a plate-like member extending along an entire length in an axial direction of said first cylinder, and
said first light-shielding portion and said second light-shielding portion are formed by bending said plate-like member along the axial direction of said first cylinder.

5. A machine according to claim 4, wherein said plate-like member is bent substantially at 90° to form said first light-shielding portion and said second light-shielding portion.

6. A machine according to claim 4, wherein said plate-like member is supported to be swingable between a first position where said first light-shielding portion covers said outer surface of said first cylinder and a second position where said first light-shielding portion separates from said outer surface of said first cylinder.

7. A machine according to claim 3, wherein said first light-shielding portion is formed to be curved along said outer surface of said first cylinder.

8. A machine according to claim 3, further comprising a cover which covers a front surface of said first cylinder,
wherein said second light-shielding portion extends toward said cover to prevent the reflected light from said second cylinder from leaking outside through a gap between said cover and said outer surface of said first cylinder.

9. A machine according to claim 3, wherein said first light-shielding portion and said second light-shielding portion are formed continuously in a direction from said outer surface of said first cylinder toward said cover.

10. A machine according to claim 1, wherein said detector comprises
an actuating member which is actuated by an external force and serves as said light-shielding member, and
a detection switch which is turned on when said actuating member is actuated.

11. A machine according to claim 10, further comprising biasing means for constantly biasing said actuating member to a position to inhibit the reflected light from said second cylinder from striking said outer surface of said first cylinder,
wherein when said actuating member moves against a biasing force of said biasing means, said detector detects an abnormality.

12. A machine according to claim 10, further comprising
a stay which is pivotally supported by a frame and to which said actuating member is fixed, and
a collar which pivots together with said stay,
wherein said detection switch has a switch portion which is turned on when said collar pivots upon movement of said actuating member.

13. A machine according to claim 1, wherein said dryer comprises an ultraviolet dryer which radiates ultraviolet rays to cure ink/vanish on the printed surface/coated surface.
